(19) United States
(12) Patent Application Publication
(10) Pub. No.: US 2015/0067238 A1
(43) Pub. Date: Mar. 5, 2015

(54) Computing Device and Method for Predicting Low Memory Conditions

(71) Applicant: SanDisk Technologies Inc., Plano, TX (US)

(72) Inventors: Alon Marcu, Tel-Mond (IL); Vsevolod Mountaniol, Givataim (IL)

(73) Assignee: SanDisk Technologies Inc., Plano, TX (US)

(21) Appl. No.: 14/219,868

(22) Filed: Mar. 19, 2014

Related U.S. Application Data
(60) Provisional application No. 61/871,706, filed on Aug. 29, 2013.

(51) Int. Cl. G06F 12/02

(52) U.S. Cl. CPC G06F 12/0246
USPC 711/103

(57) ABSTRACT

A computing device and method for predicting low memory conditions are disclosed. In one embodiment, a computing device is provided having volatile memory, non-volatile memory, and a processor. The processor generates a metric predictive of an upcoming low-memory condition in the volatile memory. The processor then compares the metric to a threshold. If the metric exceeds the threshold, the processor creates free space in the volatile memory. Other embodiments are possible, and each of the embodiments can be used alone or together in combination.

### CROSS-REFERENCE TO RELATED APPLICATION

This application claims priority to U.S. provisional patent application No. 61/871,706, filed Aug. 29, 2013, which is hereby incorporated by reference.

### BACKGROUND

One of the features of a computing device, such as a mobile phone or a tablet, is running applications (or “apps”). All of the code and data fragments of active applications are stored and accessed from relatively fast volatile memory (e.g., RAM), as compared to relatively-slower non-volatile memory (e.g., Flash). However, a computing device typically has a relatively-small amount of volatile memory as compared to non-volatile memory, so there is a limit as to the number of applications whose code and data fragments can all be loaded into volatile memory. As such, an operating system on the computing device can decide, according to its own heuristics, to end (or “kill”) one or more applications currently running in volatile memory in order to provide volatile memory resources for a different (currently-running or newly-executed) application that has a higher priority. For example, an application manager in the user space can compute a priority parameter (sometimes known as adjustment) and report this parameter to the operating system kernel. Whenever memory resources are insufficient for fulfilling a memory allocation request of a process in the kernel, the kernel can free some memory by killing a low priority processes as indicated by the adjustment parameter.

### Overview

Embodiments of the present invention are defined by the claims, and nothing in this section should be taken as a limitation on those claims.

By way of introduction, the below embodiments relate to a computing device and method for predicting low memory conditions. In one embodiment, a computing device is provided having volatile memory, non-volatile memory, and a processor. The processor generates a metric predictive of an upcoming low-memory condition in the volatile memory. The processor then compares the metric to a threshold. If the metric exceeds the threshold, the processor creates free space in the volatile memory.

Other embodiments are possible, and each of the embodiments can be used alone or together in combination. Accordingly, various embodiments will now be described with reference to the attached drawings.

### BRIEF DESCRIPTION OF THE DRAWINGS

FIG. 1 is a block diagram of an exemplary computing device of an embodiment.

FIG. 2 is a block diagram of an exemplary storage device of an embodiment.

FIG. 3 is an illustration of the functional relationship between applications, an application management layer, and an operating system kernel of an embodiment.

FIG. 4 is a flow chart of a method of an embodiment for predicting a low memory condition.

FIG. 5 is an illustration of an embodiment in which a N metrics are used to generate a global decision on whether to perform memory management to generate free memory.

FIG. 6 is a flow chart of a hibernation process of an embodiment.

FIGS. 7A and 7B are graphs showing memory consumption in volatile memory of an embodiment.

FIG. 8 is a graph showing the advantages of an embodiment.

### DETAILED DESCRIPTION OF THE PRESENTLY PREFERRED EMBODIMENTS

As mentioned above, whenever memory resources are insufficient for fulfilling a memory allocation request of a process in the kernel, the kernel can free some memory by killing a low-priority process. Low-priority processes can be indicated by a priority parameter (sometimes known as adjustment) computed by an application manager in the user space. However, the problem with this approach is that once memory resources cannot be fulfilled, it may be too late to begin performing memory management, and the performance of the computing device may be degraded. The following embodiments can be used to overcome this problem. Before turning to these and other embodiments, the following section provides a discussion of exemplary computing and storage devices that can be used with these embodiments. Of course, these are just examples, and other suitable types of computing and storage devices can be used.

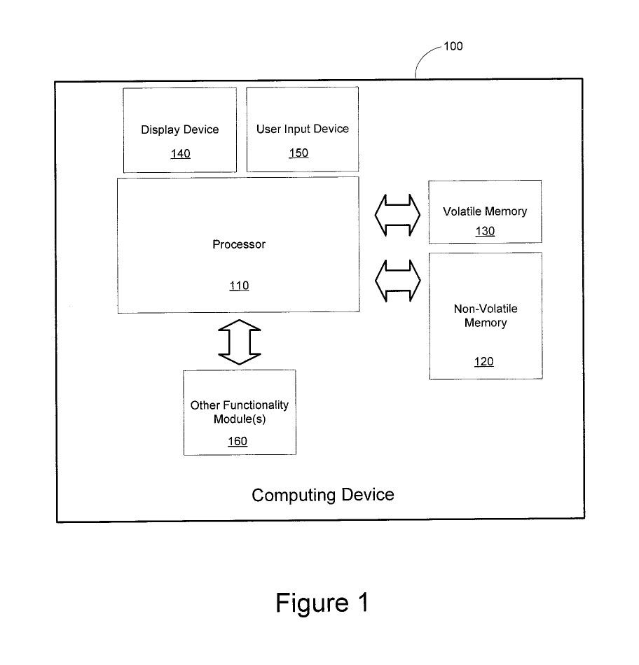

Turning now to the drawings, FIG. 1 is a block diagram of a computing device 100 of an embodiment. As shown in FIG. 1, the computing device 100 comprises a processor 110, non-volatile memory 120, volatile memory 130 (e.g., RAM), a display device 140, a user input device 150, and one or more optional other functionality module(s) 160. The computing device 100 can take any suitable form, such as, but not limited to, a mobile phone, a tablet computer, a digital media player, a game device, a personal digital assistant (PDA), a mobile (e.g., notebook, laptop) personal computer (PC), a book reader, or any combination thereof. The user input device 150 can also take any suitable form and can be separate from or integrated with the display device 140. For example, the user input device 150 can be a physical keyboard or can be a touch-sensitive surface on the display device 140. The optional other functionality module(s) 160 can also take any suitable form, depending on the nature of the computing device 100. For example, if the computing device 100 is a mobile phone, the other functionality module(s) 160 can include hardware and/or software components to make and place telephone calls. As another example, if the computing device 100 has network connectivity capabilities, the other functionality module(s) 160 can include a network interface. Of course, these are just some examples, and other implementations can be used. Also, the computing device 100 can include other components (e.g., an audio output, input-output ports, etc.) that are not shown in FIG. 1 to simplify the drawings.

The processor 110 is responsible for running the general operation of the computing device 100. This includes, for example, running an operating system, as well as various applications. The computer-readable program code for the operating system and applications can be stored in the non-volatile memory 120 and then loaded into the volatile memory 130 for execution. The following embodiments provide several examples of methods that can be performed by the processor 110.

The non-volatile and volatile memories 120, 130 can take any suitable form. For example, the volatile memory 130 can use any current or future technology for implementing random access memory (RAM). In one embodiment, the non-volatile memory 120 takes the form of a solid-state (e.g., flash) memory and can be one-time programmable, few-time programmable, or many-time programmable. The non-volatile memory 120 can also use single-level cell (SLC), multiple-level cell (MLC), triple-level cell (TLC), or other memory technologies, now known or later developed.

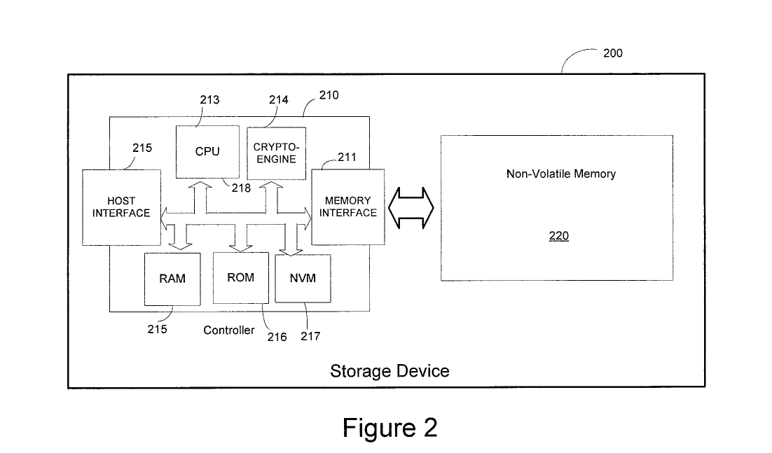

The non-volatile memory 120 can simply be a memory chip or can be part of a self-contained storage device with its own controller. An example of such a storage device 200 is shown in FIG. 2. As illustrated in FIG. 2, the storage device 200 comprises a controller 210 and non-volatile memory 220. The controller 210 comprises a memory interface 211 for interfacing with the non-volatile memory 220 and a host interface 212 for placing the storage device 200 in communication with other components of the computing device 100. As used herein, the phrase “in communication with” could mean directly in communication with or indirectly in communication with through one or more components, which may or may not be shown or described herein. For example, the computing device 100 and storage device 200 can each have mating physical connectors that allow the storage device 100 to be removably connected to the computing device 100.

The controller 210 also comprises a central processing unit (CPU) 213, an optional hardware crypto-engine 214 operative to provide encryption and/or decryption operations, read access memory (RAM) 215, read only memory (ROM) 216 which can store firmware for the basic operations of the storage device 100, and a non-volatile memory (NVM) 217 which can store a device-specific key used for encryption/decryption operations, when used. The controller 210 can be implemented in any suitable manner. For example, the controller 210 can take the form of a microprocessor or processor and a computer-readable medium that stores computer-readable program code (e.g., software or firmware) executable by the (micro)processor, logic gates, switches, an application specific integrated circuit (ASIC), a programmable logic controller, and an embedded microcontroller, for example. Suitable controllers can be obtained from Marvell or SandForce.

The storage device 200 can be embedded in or removably connected with the computing device 100. For example, the storage device 200 can take the form of an iNAND™ eSD/eMMC embedded flash drive by SanDisk Corporation or can take the form of a removable memory device, such as a Secure Digital (SD) memory card, a microSD memory card, a Compact Flash (CF) memory card, or a universal serial bus (USB) device.

Returning to FIG. 1, the non-volatile memory 120 can store computer-readable program code that is executed by the processor 110 to provide various functions of the computing device 100. For example, the non-volatile memory 120 can store computer-readable program code for one or more applications (“apps”), as well as code for an operating system kernel. When the processor 110 executes these sets of code, the processor 100 runs the software to enable their functionality.

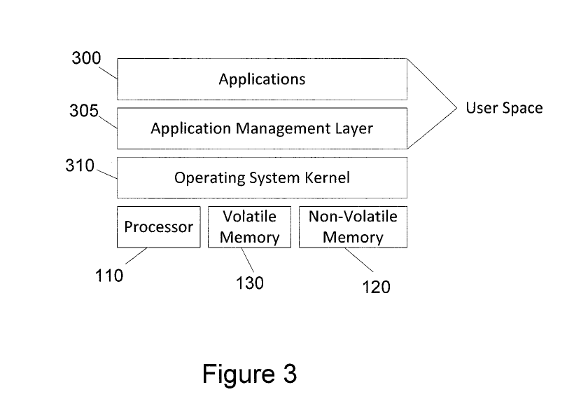

As shown in FIG. 3, a typical model for the operation of the software in the computing device 100 partitions the “space” of the software into two main components: the user space (which contains applications 300 and an application management layer 305 (or “application manager”)) and the operating system space (which contains the operating system kernel 310). In general, the operating system kernel 310 is the component of the operating system that serves as a bridge between the applications 300 and the application management layer 305 (both of which are running in the user space) and the processor 110 and non-volatile and volatile memories 120, 130 by managing the communication between these software and hardware components. The application management layer 305 is responsible for determining which of the applications 300 should reside in volatile memory 130, and the operating system kernel 310 is responsible for deciding which of the applications 300 should be allocated to the processor 110. The application management layer 305 requests a service from the operating system kernel 310 by issuing function calls, such as, for example, close, open, read, wait, and write calls.

In the user space, the relevant objects are applications (e.g., such as apps for making a phone call, taking a picture, opening a video, etc.), and each application translates into a process (or several processes) that need to run in order to support the application's functionality. Each process has a projection into the kernel space. From the operating system kernel's perspective, a process is an entity that requires resources: memory, time slots to run in, structures that describe the process, etc. The operating system kernel 310 is the process manager and allocates the memory resources and the time slots where the process can run. So, in some sense, the processes can be said to run in the operating system kernel 310; however, the operating system kernel 310 has no knowledge of the functionality of the processes. The operating system kernel 310 does not even know if a process is running in the background or foreground. From the operating system kernel's perspective, the process is defined by the resources it needs to support it.

In the user space, the application management layer 305 is aware of the functionality of each process, of the processes associated with each application 300, and of the priority of an application 300 and its associated processes. In order to support the operating system kernel 310 in its role of resource allocation to the processes running in the operating system kernel 310, the application management layer 305 in the user space computes a priority parameter, sometimes known as adjustment, and reports this parameter to the operating system kernel 310. Typically, the adjustment parameter is added to the structure defining the process (i.e., the reflection of the process in the kernel space) and will be updated on a regular basis. For example, the adjustment parameter can be defined as a 16-level parameter where a low value indicates high priority and a high value indicates low priority.

Whenever memory resources are insufficient for fulfilling a memory allocation request of a process (in the operating system kernel 310), the operating system kernel 310 may free some memory in the volatile memory 130, either by swapping (i.e., moving some data from the volatile memory 130 (e.g., RAM) into the non-volatile memory (e.g., main storage)) or by ending (or “killing”) low-priority processes (as indicated by the adjustment parameter). The operating system kernel 310 can compute a first threshold function: A=F(free memory, required memory), where A is a number in the range of the adjustment parameter. Then, the operating system kernel 310 can kill any process with an adjustment greater than (or equal) to A in order to fulfill the requests from current processes.

Because this approach reacts to low memory conditions according to “memoryless” (i.e., without relation to prior history and dynamics of memory allocation) snapshots of various system metrics, it reacts only when requests for additional memory cannot be fulfilled. However, at this stage, performing the memory management operations to create free space, such as swapping memory from RAM into main storage, may degrade overall performance and user experience. That is, the problem with this approach is that once memory resources cannot be fulfilled, it may be too late to begin performing memory management, and the performance of the computing device (e.g., a smart phone) may be degraded.

The following embodiments can be used to predict low memory conditions early enough so that free memory can be created in the volatile memory 130 early enough so the user does not experience performance degradation.

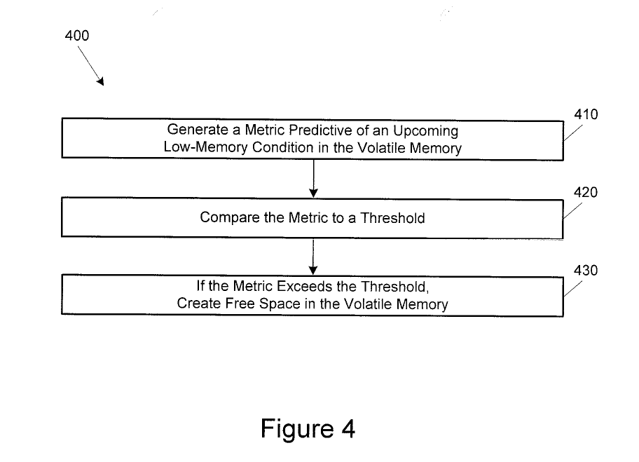

Returning to the drawings, FIG. 4 is a flow chart 400 of a method of an embodiment for predicting a low-memory condition, which can be implemented by executing computer-readable program code in the processor 110 of the computing device 100. As shown in FIG. 4, the processor 110 first generates a metric predictive of an upcoming low-memory condition in the volatile memory 130 (act 410). Next, the processor 110 compares the metric to a threshold (act 420). If the metric exceeds the threshold, the processor 110 creates free space in the volatile memory 130 (act 430). In one embodiment, these acts are performed prior to receiving a memory allocation request from an application. Thus, this embodiment is proactive, which is in contrast to the reactive prior approaches discussed above that perform memory allocation in response to a memory allocation request from an application. Further, the metric is preferably generated over a period of time, instead of merely being a snapshot of conditions at the time of the allocation request. In this way, these embodiments can predict low memory conditions so that free memory can be created in the volatile memory 130 early enough so the user does not experience performance degradation. That is, dynamic metrics can provide better predictions and help take better actions since they provide an insight into the dynamic behavior of the memory resources and can also provide an alert on an expected shortage in memory before it is noticeable by previous methods. Each of these acts will be discussed in more detail below.

As discussed above, the first act in this method is to generate a metric predictive of an upcoming low-memory condition in the volatile memory 4 (act 410). In general, the metric can take into account the history of the computing device 100 and the dynamics of the metric evolvement. The following paragraphs provide a number of examples of various metrics that can be used. However, it should be understood that the claims are not limited to any particular example unless expressly recited therein. Also, it should be understood that these are just examples, and other types of metrics can be used. Further, as will be discussed below, while a single metric can be used, multiple metrics can be used, with each of the metrics being given the same or different weights.

In one example, the metric compares an amount of memory that was allocated versus an amount of memory that was requested over a period of time. This can be measured by comparing a number of allocation requests that were granted versus a number of allocation requests that were denied. This can also be measured by comparing a size (e.g., megabits) of memory allocation requests versus a size of those memory allocation requests that were denied. Alternatively a weighted combination can be considered. Denoting a successful memory allocation by M and a failed memory request by F, the ratio between successful requests to unsuccessful requests (in a time window) may be expressed as: f(M, F)=#M/#F, where #X denotes the number of requests of type X.

A failed allocation can include not only allocations that were refused by the memory allocation unit (e.g., kmalloc, the Kernel memory allocator), but also memory requests that the memory allocation unit had difficulties in providing. The difficulty in providing a memory allocation request can be measured by the time it took for the memory allocation unit to provide the requested memory or by measuring the number of software units that were referred to for providing the request. For example, the kmalloc function for allocating memory can respond immediately to a memory request if there exists a big enough continuous chunk of memory available. Alternatively if there is not a big enough continuous chunk of memory available, then the kmalloc function can call upon sub-functions to find multiple chunks of memory that accumulate to the desired request, or it can call a swap mechanism to free some memory. A failure, F, can sometimes be associated with a memory request if the kmalloc function had to call other sub-functions before allocating the memory.

The last examples were described from the kernel's perspective and took into consideration the memory condition and memory dynamics as seen by the kernel. They did not take the user application perspective into consideration. In another embodiment, similar dynamics in the user space can be taken into consideration. According to one example, the adjustment parameter described above can be traced along a sliding window, and its dynamic behavior can be taken into account when considering which processes may be killed. Alternatively, the toggling of a process between foreground and background modes can be traced.

In another example, a metric can record successful memory allocations and failed memory allocations in a string that denotes a pattern of successful and unsuccessful memory allocation requests over a period of time. For example, the string “MMFFM” can denote two successful allocations followed by two failed allocations followed by one successful allocation. According to this example, the metric is a function of the pattern of the success/fail strings of this type and can be generated for a fixed or sliding window of a predefined or variable length. By using this type of metric, the processor 110 can take into account the specific pattern of the string and allocate memory resources accordingly. More generally, the processor 110 can take into account other patterns of allocation successes and failures (not only a moving window summary).

As another example, a metric can be a function of a number of memory allocation requests over a period of time. An increased number of memory allocation requests can indicate that enhanced memory usage is expected in the near future, even though there is enough free memory at the present moment. When the processor 110 decides that enhanced memory usage is expected, it can initiate memory management activities to free more memory.

Another exemplary metric predictive of an upcoming low-memory condition in the volatile memory 130 is based on information about one or more applications 300 received from the user space (e.g., information about the initiation or termination of an application 300 or that an application 300 is going to the background). Other examples include, but are not limited to, an amount of free space in the volatile memory 130, a cache page size, a number of processes beginning and terminating in a period of time, and an amount of memory allocated and de-allocated in a period of time. It should be noted that while several of the metrics described above were discussed as one measurement versus another measurement (e.g., the number of successful allocation versus the number of unsuccessful allocations), it should be understood that each of the metrics can stand on its own and do not necessarily need to be compared to another metric (e.g., look at the number of successful allocation without comparing it to the number of unsuccessful allocations).

It should be noted that the period of time under which a metric is measured can be a fixed window or a sliding window. Also, if multiple metrics are used, each metric can be judged under the same or different amount of time, and all or some can use a fixed window versus a sliding window. In other words, the size and fixed/sliding nature of the window can be the same for all metrics or vary for some or all metrics.

With the metric generated, the processor 110 then compares the metric with a threshold (act 420). There are many variations that can be used. For example, if there are multiple metrics, all of the metrics can be compared to the same threshold, or some or all of the metrics can be compared to different thresholds. Also, the metrics can be compared to the thresholds in a direct fashion, or some metrics can be given different weights. Further, a smoothing computation (e.g., computing an average of the metric over some time period or computing a moving average) can be performed on the metrics before comparing them to the threshold.

Also, the threshold can be predetermined (static) or dynamic. The threshold can be an absolute predefined threshold, or it can be a relative threshold (e.g., comparing the latest values of the metric to recent computations of the threshold). It is also possible to compute averages along different time periods and compare between them. For example, one embodiment may compute fast averages (e.g. where averaging of the metric is done at a high rate) and compare the results to a slow averaging process. Another embodiment can assign different weights to recent measurements versus old measurements. In another embodiment, the dynamic threshold is by itself computed by one or more of metrics over a period of time (either the same period of time as the metrics or different period of time) (e.g., average over window N vs. average over window N−1).

For example, consider the metric defined above f(M, F)=#M/#F that computes the ratio of successful allocations to unsuccessful allocations of memory. According to one implementation, a fixed threshold can be computed, such that whenever the value of f(M, F) is below the threshold, action can be taken to free memory (e.g., by swapping some memory pages from the volatile memory 130 to the non-volatile memory 120). According to another implementation, f(M, F) can be computed on different sliding windows, where the computation on a specific set of sliding windows can serve as a threshold for more recent computations on a different window. Whenever the current value of f(M, F) is lower than the threshold, action can be taken to free memory. This example demonstrates dynamic computations with fixed and relative thresholds. In particular, in this example, the threshold can be itself computed in the same way as the metric it is compared to (however at a different time window).

As noted above, averaging any of the metrics can be done by a sliding window, by a jumping window, by arithmetic averaging, and by changing the window size per parameter over time or over number of allocation operations. The computations of any of the above metrics can be computed on a short window and can be compared to computation of the metric over a large window. Whenever there is a discrepancy between the metrics of the two windows by more than a predefined threshold, pre-emptive action can be taken to free more memory. This enables “adaptable thresholds” to detect dynamically significant changes in a metric compared to its latest history.

In another embodiment, a weight function is computed for each process in addition to the threshold function, where the weight function takes into account the adjustment parameter for the process and the amount of memory consumed by the process along time. For example, the weight function can be a product of the adjustment variable with the memory consumption. According to this embodiment, for example, the processor 110 can kill any application whose adjustment parameter is greater than F(free memory). This is similar to the decision in prior approaches, but, with this approach, the priorities for the killing of processes can be made according to their weight function, where “heavy” processes will be killed first.

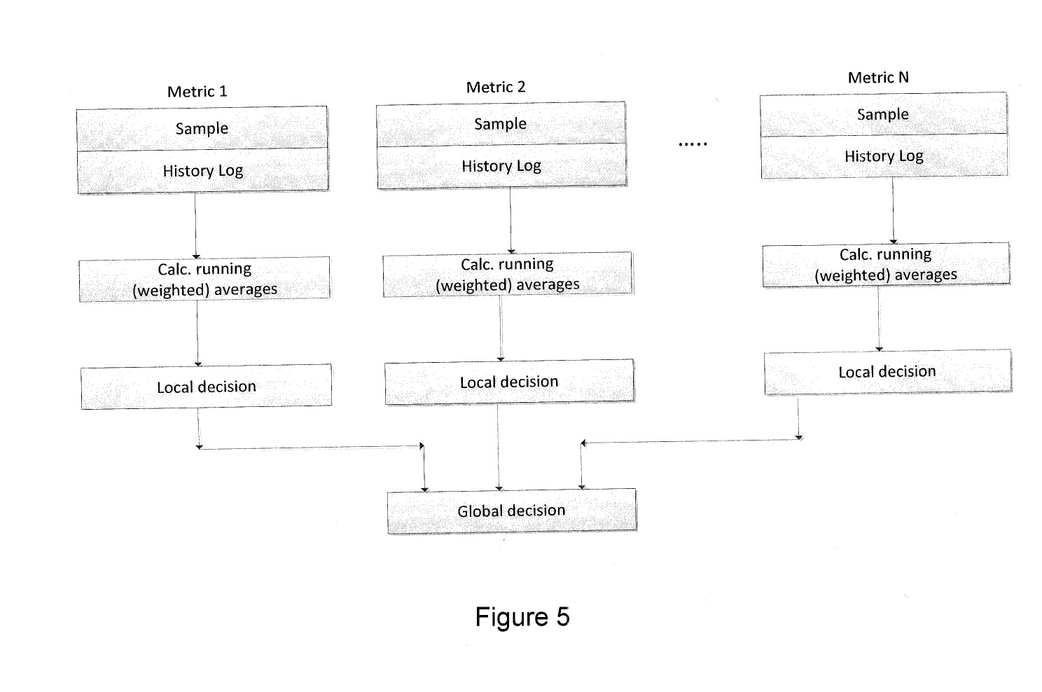

FIG. 5 is an illustration that illustrates several of the above concepts. In FIG. 5, N metrics are being considered, where each metric calculates a running (weighted average) of a sample and history log and then compares the result to a threshold value to reach a “local decision” for that metric. A local decision can be based on comparing two averages (e.g., short term versus long term), comparing one average versus a threshold, or comparing an average function at two different times (e.g., time t versus time t−n). The local decisions of all the metrics are then compared to generate a “global decision” on whether to create free memory.

If the metric exceeds the threshold, the processor 110 creates free memory (act 430). In general, there is a need to create free space because of the limited size of the volatile memory 130. By way of background, the computer-readable program code and data fragments for an application can be copied from the non-volatile memory 120 and placed in the volatile memory 130 for execution. This avoids the performance delays associated with loading code or data fragments from non-volatile to volatile memory while the application is running. However, the size of volatile memory 130 is relatively small as compared to the size of the non-volatile memory, so there is a limit as to the number of applications whose code and data fragments can all be running from volatile memory 130.

When the metric exceeds the threshold and free space needs to be created in the volatile memory 130, many different types of techniques can be used. For example, as noted above, the processor 110 can decide to end (or “kill”) one or more applications currently running in the volatile memory 130 in order to provide volatile memory resources for a different (currently-running or newly-executed) application that has a higher priority. As another alternative, when the threshold is exceeded, the processor 110 can change the priority level that is used to determine when an application is to be terminated (or swapped or hibernated, as will be discussed below).

Some systems, such as mobile phones, may wish to avoid “killing” an open application because killing an application may result in slower performance. To avoid killing an application, the processor 110 can perform a “swapping” operation, in which data associated with a low-priority application is copying from the volatile memory 130 and stored in the non-volatile memory 120. So, when the metric exceeds the threshold and free space needs to be create in the volatile memory 130, the processor 110 can perform a swapping operation or even change the rate of swapping memory.

As an alternative to swapping, a hibernation process can be used. “Hibernation” refers to the process of stopping an application, moving all of the application's memory pages from volatile memory 130 to non-volatile memory 120, and storing at least some of the application's state parameters in the non-volatile memory 120, so the application can later be restored from the non-volatile memory 120 in the same state that the application was in before the application was placed in hibernation. A hibernated application can be removed from the operating system's scheduler queue (or tagged as non-runnable). Hibernating an application can be simpler and less expensive than killing an application.

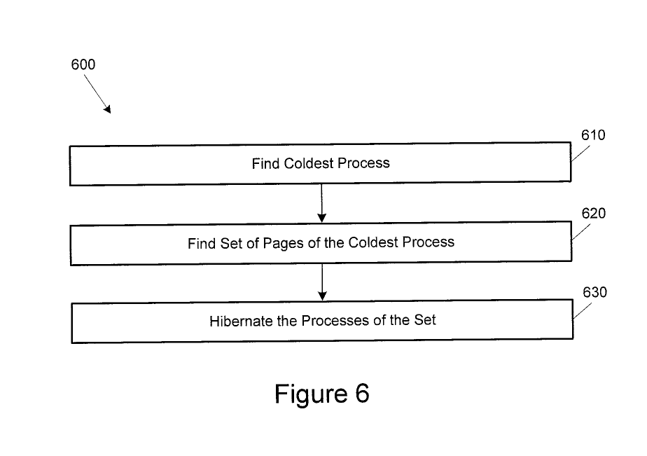

FIG. 6 is a flow chart of a method for hibernating an application. In this example, a number of processes P1, . . . , Pn of applications are running in parallel, and their associated memory pages are loaded into the volatile memory (RAM) 130. When the metric exceeds the threshold and free space needs to be created in the volatile memory 130, the processor 110 identifies which application to hibernate by looking for the coldest process (e.g., the process that is the least used) (act 610). The processor 110 then finds the set of memory pages in the volatile memory 130 that are associated with the coldest process (act 630) and then the processor 110 hibernates the coldest process (act 630).

Other ways of creating free space can be used. For example, in another embodiment, free memory in the volatile memory 130 is created by moving an application to a compressed memory zone. Also, the processor 110 can decide whether to kill or swap or hibernate an application by determining priorities for the applications and processes according to dynamic behavior of the application or process.

Irrespective of what technique is used to create the free space, by triggering the creation of free space on a predicted low memory condition rather than on a present low memory condition, these embodiments avoid the performance penalty associated with prior approaches that create free space in response to a request from an application for more memory. In this way, these embodiments provide for better memory management by proactively reacting to early predictions of low memory conditions and freeing memory in advance of the actual need for the memory. This approach is fundamentally different from previous approaches as it does not decide according to a snapshot of the current status of the system but according to a history record of the system. By processing different metrics and reacting accordingly, these embodiments enable both noise filtering and the ability to react to changing dynamics of the computing device 100 (e.g., by detecting a sudden change in the behavior of the device 100, such as a burst of memory allocation). This is advantageous over previous methods because previous methods do not protect from occasional deviations. Memory resource needs can be of a sinusoidal or otherwise varying nature (e.g., free now, busy after 10 seconds, free again after 20 seconds, etc.), and garbage collection frees buffers and swaps out pages of memory periodically due to memory condition. These embodiments can be used to equalize this situation. For example, if the sliding window is large enough, it can predict a real rising memory pressure situation and prevent false responses.

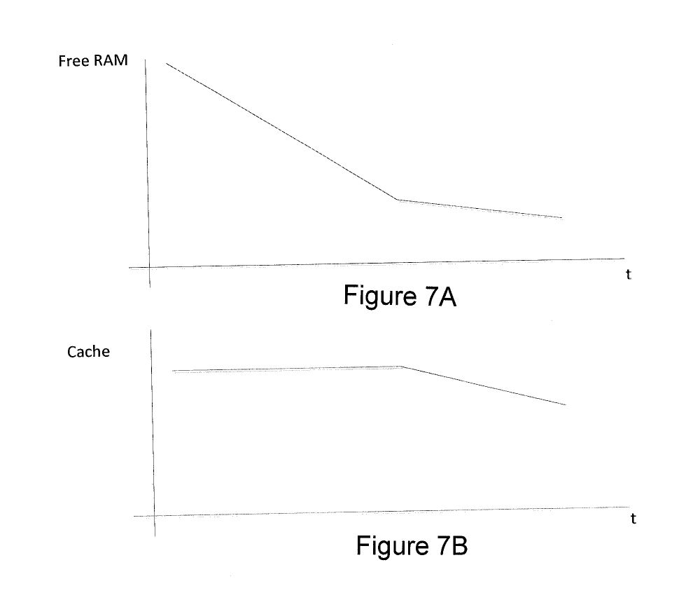

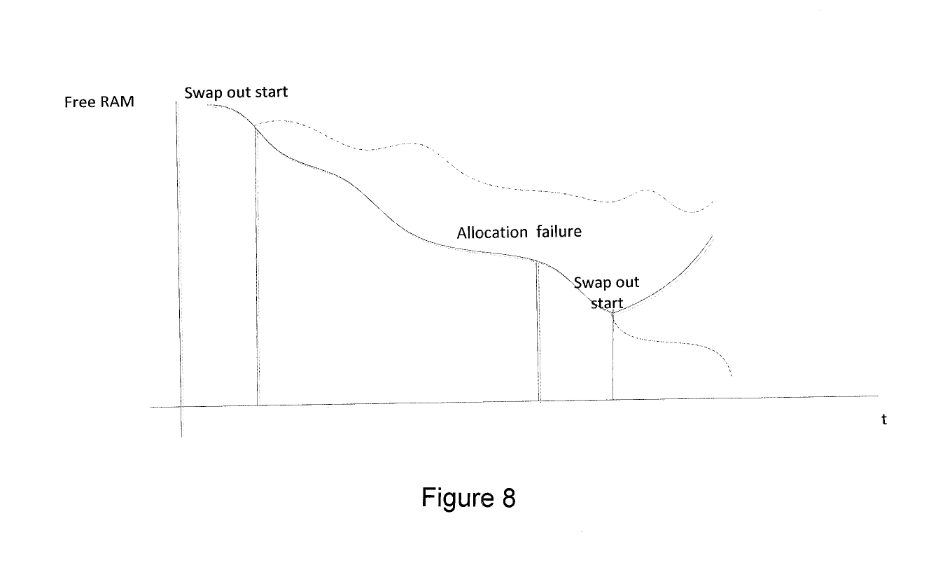

FIGS. 7A and 7B and FIG. 8 illustrate these advantages. FIG. 7A shows that, when additional memory is required, memory is first allocated from free RAM. Only after the amount of free RAM becomes dangerously low does the processor 110 begin to free memory from the non-volatile memory cache 120 and allocate this memory. At this point, the level at which the free RAM decreases becomes milder since some of the memory allocations are fulfilled with memory that was freed from the cache. FIG. 7B shows that, inside the volatile memory cache, the processor 110 first tries to allocate pages that have not changed since it is an easy and simple procedure. If the processor 110 needs to free some pages that have been changed, the processor 110 stores them first in the main non-volatile memory 130 in order that data will not be lost.

FIG. 8 is a graph that shows the advantages of these embodiments (dashed line) over the prior approach (solid line) discussed above. FIG. 8 shows that, with the prior approach, free RAM decreases until an allocation failure is detected, at which time a swap-out procedure is started to create free space. In contrast, with these embodiment, the low memory condition is predicted, so that the swap-out process can be started much sooner. Thus, these embodiments avoid reaching a low point of available memory that can cause stress on the system and lead to non-optimal use of the memory. Using the method of these embodiments results in a more moderate rate of “eating up” the memory. Thus, no drastic swap action is required, and the available memory resources are higher than with the prior approach of using the memory.

These embodiments can be implemented in any suitable manner in the computing device 100. For example, as discussed above, the processor 110 of the computing device 100 can execute an operating system kernel 310 as well as applications 300 and an application management layer 310 running in the user space. The operating system kernel 310 can be Linux or incompatible with Linux. Operating systems with a kernel incompatible with Linux include, but are not limited to, Windows operating systems (e.g., Windows 8 NT and Windows 8) and Apple operating systems (e.g., iOS and Mac-OSx).

In one embodiment, the operating system kernel 310 generates the metric, compares the metric to the threshold, and creates the free memory in the volatile memory 130. In another embodiment, the user space triggers the generation of the metric by the operating system kernel 310, wherein the operating system kernel 310 returns the metric to the user space, and wherein the user space compares the metric to the threshold. In yet another embodiment, the operating system kernel 310 triggers itself to generate the metric, and wherein the user space requests the metric from the operating system kernel 310 and compares the metric to the threshold. Further, the generating, comparing, and initiating acts can be performed by sending function calls from the application management layer 305 to the operating system kernel 310.

It is intended that the foregoing detailed description be understood as an illustration of selected forms that the invention can take and not as a definition of the invention. It is only the following claims, including all equivalents, that are intended to define the scope of the claimed invention. Finally, it should be noted that any aspect of any of the preferred embodiments described herein can be used alone or in combination with one another.

What is claimed is:

1. A computing device comprising:
volatile memory;
non-volatile memory; and
a processor in communication with the volatile and non-volatile memories, the processor configured to:
generate a metric predictive of an upcoming low-memory condition in the volatile memory, wherein the metric is generated over a period of time;
compare the metric to a threshold; and
if the metric exceeds the threshold, create free space in the volatile memory.

2. The computing device of claim 1, wherein the metric is generated and the free space is created prior to receiving a memory allocation request from an application.

3. The computing device of claim 1, wherein the metric compares an amount of memory that was allocated versus an amount of memory that was requested over the period of time.

4. The computing device of claim 3, wherein the metric compares a number of allocation requests that were granted versus a number of allocation requests that were denied.

5. The computing device of claim 3, wherein the metric compares a size of memory allocation requests versus a size of those memory allocation requests that were denied.

6. The computing device of claim 1, wherein the metric comprises a pattern of successful and unsuccessful memory allocation requests over the period of time.

7. The computing device of claim 1, wherein the metric is a function of a number of memory allocation requests over the period of time.

8. The computing device of claim 1, wherein the metric is based on information about one or more applications received from an application manager in a user space.

9. The computing device of claim 1, wherein the metric includes one or more of the following: an amount of free space in the volatile memory, a cache page size, a number of processes beginning and terminating in the period of time, an amount of memory allocated in the period of time, an amount of memory de-allocated in the period of time, an amount of memory that was requested over the period of time, a number of allocation requests that were granted over the period of time, a number of allocation requests that were denied over the period of time, a size of memory allocation requests over the period of time, a size of memory allocation requests that were denied over the period of time, a pattern of successful memory allocations over the period of time, and a pattern of unsuccessful memory allocation requests over the period of time.

10. The computing device of claim 1, wherein the metric is considered over a fixed window of time.

11. The computing device of claim 1, wherein the metric is considered over a moving window of time.

12. The computing device of claim 1, wherein the processor is further configured to generate a plurality of metrics and compare the plurality of metrics to the threshold.

13. The computing device of claim 12, wherein the processor is further configured to perform a smoothing computation on the plurality of metrics before comparing them to the threshold.

14. The computing device of claim 1, wherein the threshold is predetermined.

15. The computing device of claim 1, wherein the threshold is dynamic.

16. The computing device of claim 15, wherein the threshold is by itself computed by one or more of metrics over the same or different period of time.

17. The computing device of claim 1, wherein the free space in the volatile memory is created by swapping at least some data from the volatile memory to the non-volatile memory.

18. The computing device of claim 1, wherein the free space in the volatile memory is created by terminating an application occupying space in the volatile memory.

19. The computing device of claim 1, wherein the free space in the volatile memory is created by hibernating an application occupying space in the volatile memory.

20. The computing device of claim 1, wherein the free space in the volatile memory is created by changing a priority level of applications to be swapped, terminated, or hibernated.

21. The computing device of claim 1, wherein the free space in the volatile memory is created by changing a rate of swapping memory.

22. The computing device of claim 1, wherein the free space in the volatile memory is created by moving an application to a compressed memory zone.

23. The computing device of claim 1, wherein the processor is configured to implement an operating system kernel and a user space.

24. The computing device of claim 23, wherein the operating system kernel generates the metric, compares the metric to the threshold, and creates the free space in the volatile memory.

25. The computing device of claim 23, wherein the user space triggers the generation of the metric by the operating system kernel, wherein the operating system kernel returns the metric to the user space, and wherein the user space compares the metric to the threshold.

26. The computing device of claim 23, wherein the operating system kernel triggers itself to generate the metric, and wherein the user space requests the metric from the operating system kernel and compares the metric to the threshold.

27. The computing device of claim 23, wherein the generating, comparing, and initiating are performed by sending function calls from an application management layer running in the user space to the operating system kernel.

28. The computing device of claim 23, wherein the operating system kernel is incompatible with Linux.

29. The computing device of claim 23, wherein the operating system kernel is Linux:

30. The computing device of claim 1, wherein the non-volatile memory is part of a storage device comprising a controller, and wherein the storage device is embedded in the computing device.

31. The computing device of claim 1, wherein the non-volatile memory is part of a storage device comprising a controller, and wherein the storage device is removably connected to the computing device.

32. The computing device of claim 1, wherein the computing device is a mobile phone.

33. The computing device of claim 1, wherein the computing device is a tablet.

34. A method for predicting low memory conditions, the method comprising:
performing the following in a computing device having volatile memory and non-volatile memory:
generating a metric predictive of an upcoming low-memory condition in the volatile memory, wherein the metric is generated over a period of time;
comparing the metric to a threshold; and
if the metric exceeds the threshold, creating free space in the volatile memory.

35. The method of claim 34, wherein the metric is generated and the free space is created prior to receiving a memory allocation request from an application.

36. The method of claim 34, wherein the metric compares an amount of memory that was allocated versus an amount of memory that was requested over the period of time.

37. The method of claim 36, wherein the metric compares a number of allocation requests that were granted versus a number of allocation requests that were denied.

38. The method of claim 36, wherein the metric compares a size of memory allocation requests versus a size of those memory allocation requests that were denied.

39. The method of claim 34, wherein the metric comprises a pattern of successful and unsuccessful memory allocation requests over the period of time.

40. The method of claim 34, wherein the metric is a function of a number of memory allocation requests over the period of time.

41. The method of claim 34, wherein the metric is based on information about one or more applications received from an application manager in a user space.

42. The method of claim 34, wherein the metric includes one or more of the following: an amount of free space in the volatile memory, a cache page size, a number of processes beginning and terminating in the period of time, an amount of memory allocated in the period of time, an amount of memory de-allocated in the period of time, an amount of memory that was requested over the period of time, a number of allocation requests that were granted over the period of time, a number of allocation requests that were denied over the period of time, a size of memory allocation requests over the period of time, a size of memory allocation requests that were denied over the period of time, a pattern of successful memory allocations over the period of time, and a pattern of unsuccessful memory allocation requests over the period of time.

43. The method of claim 34, wherein the metric is considered over a fixed window of time.

44. The method of claim 34, wherein the metric is considered over a moving window of time.

45. The method of claim 34 further comprising generating a plurality of metrics and comparing the plurality of metrics to the threshold.

46. The method of claim 45 further comprising performing a smoothing computation on the plurality of metrics before comparing them to the threshold.

47. The method of claim 34, wherein the threshold is predetermined.

48. The method of claim 34, wherein the threshold is dynamic.

49. The method of claim 48, wherein the threshold is by itself computed by one or more of metrics over the same or different period of time.

50. The method of claim 34, wherein the free space in the volatile memory is created by swapping at least some data from the volatile memory to the non-volatile memory.

51. The method of claim 34, wherein the free space in the volatile memory is created by terminating an application occupying space in the volatile memory.

52. The method of claim 34, wherein the free space in the volatile memory is created by hibernating an application occupying space in the volatile memory.

53. The method of claim 34, wherein the free space in the volatile memory is created by changing a priority level of applications to be swapped, terminated, or hibernated.

54. The method of claim 34, wherein the free space in the volatile memory is created by changing a rate of swapping memory.

55. The method of claim 34, wherein the free space in the volatile memory is created by moving an application to a compressed memory zone.

56. The method of claim 34, wherein the computing device is configured to implement an operating system kernel and a user space.

57. The method of claim 56, wherein the operating system kernel generates the metric, compares the metric to the threshold, and creates the free space in the volatile memory.

58. The method of claim 56, wherein the user space triggers the generation of the metric by the operating system kernel, wherein the operating system kernel returns the metric to the user space, and wherein the user space compares the metric to the threshold.

59. The method of claim 56, wherein the operating system kernel triggers itself to generate the metric, and wherein the user space requests the metric from the operating system kernel and compares the metric to the threshold.

60. The method of claim 56, wherein the generating, comparing, and initiating are performed by sending function calls from an application management layer running in the user space to the operating system kernel.

61. The method of claim 56, wherein the operating system kernel is incompatible with Linux.

62. The method of claim 56, wherein the operating system kernel is Linux:

63. The method of claim 34, wherein the non-volatile memory is part of a storage device comprising a controller, and wherein the storage device is embedded in the computing device.

64. The method of claim 34, wherein the non-volatile memory is part of a storage device comprising a controller, and wherein the storage device is removably connected to the computing device.

65. The method of claim 34, wherein the computing device is a mobile phone.

66. The method of claim 34, wherein the computing device is a tablet.
